(19) United States
(12) Patent Application Publication
(10) Pub. No.: US 2014/0322380 A1
(43) Pub. Date: Oct. 30, 2014

(54) DIGITAL EMBOSSING DEVICE

(71) Applicant: THOMAS NATHANIEL TOMBS, Rochester, NY (US)

(72) Inventor: THOMAS NATHANIEL TOMBS, Rochester, NY (US)

(21) Appl. No.: 13/873,306

(22) Filed: Apr. 30, 2013

(51) Int. Cl. B29C 59/02

(52) U.S. Cl. CPC B29C 59/02
USPC 425/385

(57) ABSTRACT

A device for embossing a receiver is disclosed. The device includes a means for depositing an embossing pattern of embossing particles means to press the receiver of receiver between a hard nip roller and a compliant nip roller, the pressure selected so that with a large enough load so that the embossing pattern permanently deforms the receiver; wherein, the embossing pattern consists of a digitally created pattern of embossing toner particles having an embossing-pattern thickness corresponding to a fixed stack height of at least 30% of the thickness of the receiver.

### CROSS REFERENCE TO RELATED APPLICATIONS

Reference is made to commonly-assigned, co-pending U.S. patent application Ser. No. ______ (Kodak Docket K001295), filed concurrently herewith, entitled “DIGITAL EMBOSSING AND CREASING” by Thomas N. Tombs, U.S. patent application Ser. No. ______ (Kodak Docket K001461), filed concurrently herewith, entitled “DIGITAL EMBOSSING AND CREASING SHEET”, by Thomas N. Tombs, U.S. patent application Ser. No. ______ (Kodak Docket K001462), by Thomas N. Tombs, filed concurrently herewith, entitled “DIGITAL EMBOSSING AND CREASING BEFORE PRINTING”, by Thomas N. Tombs, the disclosures of which are incorporated herein.

### FIELD OF THE INVENTION

This invention relates in general to electrographic printing, and more particularly to printing and embossing a receiver sheet.

### BACKGROUND OF THE INVENTION

One method for printing images on a receiver member is referred to as electrography. In this method, an electrostatic image is formed on a dielectric member by uniformly charging the dielectric member and then discharging selected areas of the uniform charge to yield an image-wise electrostatic charge pattern. Such discharge is typically accomplished by exposing the uniformly charged dielectric member to actinic radiation provided by selectively activating particular light sources in an LED array or a laser device directed at the dielectric member. After the image-wise charge pattern is formed, the pigmented (or in some instances, non-pigmented) marking particles are given a charge, substantially opposite the charge pattern on the dielectric member and brought into the vicinity of the dielectric member so as to be attracted to the image-wise charge pattern to develop such pattern into a visible image.

Thereafter, a suitable receiver member (e.g., a cut sheet of plain bond paper) is brought into juxtaposition with the marking particle developed image-wise charge pattern on the dielectric member. A suitable electric field is applied to transfer the marking particles to the receiver member in the image-wise pattern to form the desired print image on the receiver member. The receiver member is then removed from its operative association with the dielectric member and the marking particle print image is permanently fixed to the receiver member typically using heat, or pressure and heat. Multiple layers or marking materials can be overlaid on one receiver, for example, layers of different color particles can be overlaid on one receiver member to form a multi-color print image on the receiver member after fixing.

With the improved print image quality, print providers and customers alike have been looking at ways to expand the use of electrographically produced prints. In certain classes of printing, a tactile feel to the print referred to as embossing is considered to be highly desirable. Specifically, ultra-high quality printing such as for stationary headers or for business cards use embossed paper, in which regions of the paper surface are raised to give a tactile feel to the resultant print output. In other instances, the embossing is readily visible and provides a decorative finish to the sheet.

Moreover, print providers have also been looking for ways to efficiently create patterned embossed regions using variable data to permit the embossing effect to be customized for each job or even for each sheet without requiring the printer provider to maintain large stocks of pre-embossed receiver. Moreover, print providers have been looking for cost effective ways to deposit additional toner on top of the embossed receiver to create visible images on the decorative sheets.

### SUMMARY OF THE INVENTION

A device for embossing a sheet comprising means for depositing a digitally created embossing pattern of embossing particles on the image bearing sheet, wherein the embossing pattern has an embossing-pattern thickness corresponding to a fixed stack height of at least 30% of the thickness of the sheet, wherein the embossing particles have average diameters greater than the average diameters of the toner particles of the image toner; and means for pressing the image bearing sheet of paper between a hard nip roller and a compliant nip roller, the pressure being selected so that the embossing pattern permanently deforms the sheet.

The present invention provides an embossing pattern on a receiver such as paper, wherein the embossing pattern is produced digitally.

### BRIEF DESCRIPTION OF THE DRAWINGS

FIG. 1 shows an elevational cross-section of an electrophotographic printer suitable for use with various embodiments.

FIG. 2 shows an elevational cross-section of one printing module of the electrophotographic printer of FIG. 1.

FIG. 3A shows a receiver bearing a toner image on side 1.

FIG. 3B shows a receiver bearing a toner image fused on side 1 and layer of embossing particles also on side 1.

FIG. 3C shows the receiver after it has passed through embossing rollers and becomes deformed in the area of embossing particles.

FIG. 3D shows the embossed receiver after the removal of the embossing particles.

FIG. 4A shows a receiver bearing a toner image.

FIG. 4B shows a receiver sheet bearing a toner image fused on side 1 and the layer of embossing particles on side 2.

FIG. 4C shows the receiver after it has passed through embossing rollers and becomes deformed in the area of embossing particles.

FIG. 4D shows the embossed receiver after the removal of the embossing particles.

FIG. 5 shows an elevational cross-section of an electrophotographic printer with an inline embossing station suitable for use with various embodiments.

FIG. 6 shows an elevational cross-section of an electrophotographic printer with an inline embossing station suitable for use with various embodiments.

FIG. 7 shows an elevational cross-section of an embossing device suitable for use with various embodiments.

FIG. 8 shows an elevational cross-section of an electrophotographic printer with an inline embossing station suitable for use with various embodiments using two embossing sheets or endless webs

### DETAILED DESCRIPTION OF THE INVENTION

As used herein, “sheet” is a discrete piece of media, such as receiver media for an electrophotographic printer (described below). Sheets have a length and a width. Sheets are folded along fold axes (e.g., positioned in the center of the sheet in the length dimension, and extending the full width of the sheet). The folded sheet contains two “leaves,” each leaf being that portion of the sheet on one side of the fold axis. The two sides of each leaf are referred to as “pages.” “Face” refers to one side of the sheet, whether before or after folding.

As used herein, “toner particles” are particles of one or more material(s) that are transferred by an electrophotographic (EP) printer to a receiver to produce a desired effect or structure (e.g., a print image, texture, pattern, or coating) on the receiver. Toner particles can be ground from larger solids, or chemically prepared (e.g., precipitated from a solution of a pigment and a dispersant using an organic solvent), as is known in the art. Toner particles can have a range of diameters (e.g., less than 8 μm, on the order of 10-15 μm, up to approximately 30 μm, or larger), where “diameter” preferably refers to the volume-weighted median diameter, as determined by a device such as a Coulter Multisizer.

As used herein, “embossing particles” are particles of one or more material(s) that are transferred by an electrophotographic (EP) printer to a receiver to produce a desired effect or structure (e.g., an embossed image, texture, or pattern) on the receiver. Embossing particles can be ground from larger solids, or chemically prepared (e.g., precipitated from a solution of a pigment and a dispersant using an organic solvent), as is known in the art. Embossing particles can have a range of diameters preferably 30 μm, or larger, where “diameter” preferably refers to the volume-weighted median diameter, as determined by a device such as a Coulter Multisizer. When practicing this invention, it is preferable to use larger embossing particles to obtain the desirable embossing stack heights that would enable macroscopic deformation of the receiver after embossing.

“Toner” refers to a material or mixture that contains toner particles, and that can be used to form an image, pattern, or coating when deposited on an imaging member including a photoreceptor, a photoconductor, or an electrostatically-charged or magnetic surface. Toner can have colorants, typically a dye or pigment of various colors or hues or toner can be free of colorants for applications involving clear toner, such as gloss control.

Embossing particles can be made of the same material as toner particles. Embossing particles can be clear or can be colored for ease of use. Typically, embossing particles are not used to form an image, although there is nothing in this invention that would preclude such use of embossing particles. Embossing particles should have a relatively high stiffness relative to the receiver so that when embossing the receiver is deformed preferentially.

In single-component or mono-component development systems, “developer” refers to toner alone. In dual-component, two-component, or multi-component development systems, “developer” refers to a mixture including toner particles and magnetic carrier particles, which can be electrically-conductive or non-conductive. The same term developer can be applied to a mixture of carrier particles and embossing particles.

The electrophotographic process can be embodied in devices including printers, copiers, scanners, and facsimiles, and analog or digital devices, all of which are referred to herein as “printers.” Various embodiments described herein are useful with electrostatographic printers such as electrophotographic printers that employ toner developed on an electrophotographic receiver, and ionographic printers and copiers that do not rely upon an electrophotographic receiver. Electrophotography and ionography are types of electrostatography (printing using electrostatic fields), which is a subset of electrography (printing using electric fields). The present invention can be practiced using any type of electrographic printing system, including electrophotographic and ionographic printers.

A digital reproduction printing system (“printer”) typically includes a digital front-end processor (DFE), a print engine (also referred to in the art as a “marking engine”) for applying toner to the receiver, and one or more post-printing finishing system(s) (e.g., a UV coating system, a glosser system, or a laminator system). A printer can reproduce pleasing black-and-white or color images onto a receiver. A printer can also produce selected patterns of toner on a receiver, which patterns (e.g., surface textures) do not correspond directly to a visible image.

The DFE receives input electronic files (such as Postscript command files) composed of images from other input devices (e.g., a scanner, a digital camera or a computer-generated image processor). Within the context of the present invention, images can include photographic renditions of scenes, as well as other types of visual content such as text or graphical elements. Images can also include invisible content such as specifications of texture, gloss or protective coating patterns.

The DFE can include various function processors, such as a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, paper type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system that accounts for characteristics of the image printing process implemented in the print engine (e.g., the electrophotographic process) to provide known, consistent color reproduction characteristics. The color management system can also provide known color reproduction for different inputs (e.g., digital camera images or film images). Color management systems are well-known in the art, and any such system can be used to provide color corrections in accordance with the present invention.

In an embodiment of an electrophotographic modular printing machine useful with various embodiments (e.g., the NEXPRESS 2100 printer manufactured by Eastman Kodak Company of Rochester, N.Y.) color-toner print images are made in a plurality of color imaging modules arranged in tandem, and the print images are successively electrostatically transferred to a receiver adhered to a transport web moving through the modules. Colored toners include colorants, (e.g., dyes or pigments) which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

Electrophotographic printers having the capability to also deposit clear toner using an additional imaging module are also known. The provision of a clear-toner overcoat to a color print is desirable for providing features such as protecting the print from fingerprints, reducing certain visual artifacts or providing desired texture or surface finish characteristics. Clear toner uses particles that are similar to the toner particles of the color development stations but without colored material (e.g., dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective color toners are deposited one upon the other at respective locations on the receiver and the height of a respective color toner stack is the sum of the toner heights of each respective color. Uniform stack height provides the print with a more even or uniform gloss.

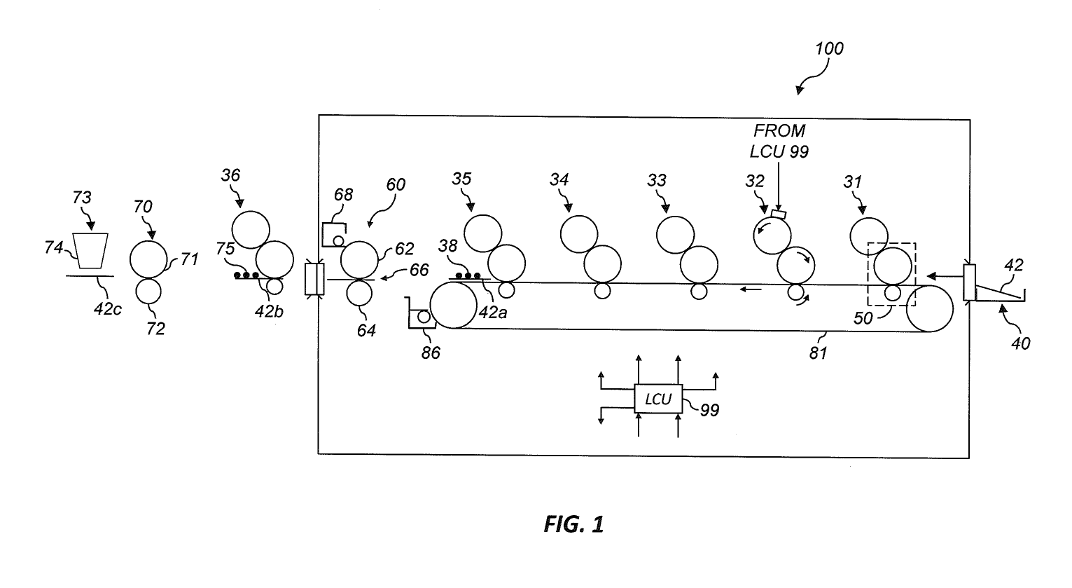

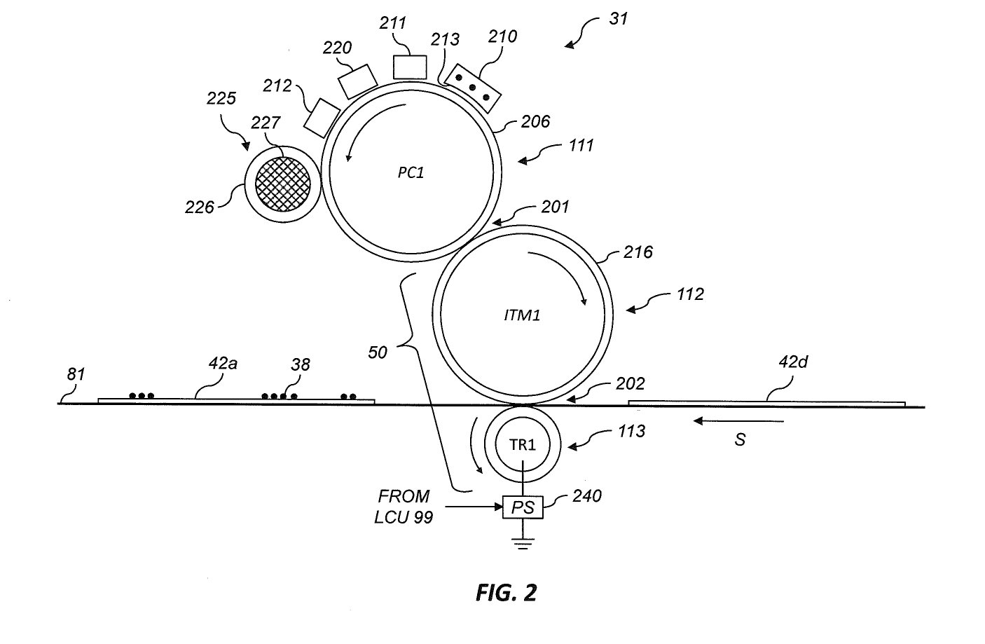

FIGS. 1 and 2 are elevational cross-sections showing portions of a typical electrophotographic printer 100 useful with various embodiments. Printer 100 is adapted to produce images, such as single-color images (i.e., monochrome images), or multicolor images such as CMYK, or pentachrome (five-color) images, on a receiver. Multicolor images are also known as “multi-component” images. One embodiment involves printing using an electrophotographic print engine having five sets of single-color image-producing or image-printing stations or modules arranged in tandem, but more or less than five colors can be combined on a single receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, also known as electrophotographic imaging subsystems. Each printing module 31, 32, 33, 34, 35 produces a single-color toner image for transfer using a respective transfer subsystem 50 (for clarity, only one is labeled) to a receiver 42 successively moved through the printing modules, 31, 32, 33, 34, 35. Receiver 42 is transported from supply unit 40, which can include active feeding subsystems as known in the art, into printer 100. In various embodiments, the visible image can be transferred directly from an imaging roller to a receiver, or from an imaging roller to one or more transfer roller(s) or belt(s) in sequence in transfer subsystem 50, and then to receiver 42. Receiver 42 is, for example, a selected section of a web of, or a cut sheet of, planar media such as paper or transparency film.

Each receiver 42, during a single pass through the five printing modules, 31, 32, 33, 34, 35 can have transferred in registration thereto up to five single-color toner images to form a pentachrome image. As used herein, the term “pentachrome” implies that, in a print image, combinations of various of the five colors are combined to form other colors on the receiver 42 at various locations on the receiver 42, and that all five colors participate to form process colors in at least some of the subsets. That is, each of the five colors of toner can be combined with toner of one or more of the other colors at a particular location on the receiver 42 to form a color different than the colors of the toners combined at that location. In an exemplary embodiment, printing module 31 forms black (K) print images, printing module 32 forms yellow (Y) print images, printing module 33 forms magenta (M) print images, and printing module 34 forms cyan (C) print images.

Printing module 35 can form a red, blue, green, or other fifth print image, including an image formed from a clear toner (e.g., one lacking pigment). The four subtractive primary colors, cyan, magenta, yellow, and black, can be combined in various combinations of subsets thereof to form a representative spectrum of colors. The color gamut of a printer (i.e., the range of colors that can be produced by the printer) is dependent upon the materials used and the process used for forming the colors. The fifth color can therefore be added to improve the color gamut. In addition to adding to the color gamut, the fifth color can also be a specialty color toner or spot color, such as for making proprietary logos or colors that cannot be produced with only CMYK colors (e.g., metallic, fluorescent, or pearlescent colors), or a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Printer 100 includes main printer apparatus logic and control unit (LCU) 99, which receives input signals from various sensors associated with printer 100 and sends control signals to components of printer 100. LCU 99 can include a microprocessor incorporating suitable look-up tables and control software executable by the LCU 99. It can also include a field-programmable gate array (FPGA), programmable logic device (PLD), programmable logic controller (PLC) (with a program in, e.g., ladder logic), microcontroller, or other digital control system. LCU 99 can include memory for storing control software and data. In some embodiments, sensors associated with the fuser module 60 provide appropriate signals to the LCU 99. In response to the sensor signals, the LCU 99 issues command and control signals that adjust the heat or pressure within fusing nip 66 and other operating parameters of fuser module 60. This permits printer 100 to print on receivers 42 of various thicknesses and surface finishes, such as glossy or matte.

Image data for printing by printer 100 can be processed by a raster image processor (RIP; not shown), which can include a color separation screen generator or generators. The output of the RIP can be stored in frame or line buffers for transmission of the color separation print data to each of a set of respective LED writers associated with the printing modules 31, 32, 33, 34, 35 (e.g., for black (K), yellow (Y), magenta (M), cyan (C), and red (R) color channels, respectively). The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer 100. The RIP can perform image processing processes (e.g., color correction) in order to obtain the desired color print. Color image data is separated into the respective colors and converted by the RIP to halftone dot image data in the respective color (for example, using halftone matrices, which provide desired screen angles and screen rulings). The RIP can be a suitably-programmed computer or logic device and is adapted to employ stored or computed halftone matrices and templates for processing separated color image data into rendered image data in the form of halftone information suitable for printing. These halftone matrices can be stored in a screen pattern memory (SPM).

FIG. 2 shows additional details of printing module 31, which is representative of printing modules 32, 33, 34, 35, and 36 (FIG. 1). Photoreceptor 206 of imaging member 111 includes a photoconductive layer formed on an electrically conductive substrate. The photoconductive layer is an insulator in the substantial absence of light so that electric charges are retained on its surface. Upon exposure to light, the charge is dissipated. In various embodiments, photoreceptor 206 is part of, or disposed over, the surface of imaging member 111, which can be a plate, drum, or belt. Photoreceptors can include a homogeneous layer of a single material such as vitreous selenium or a composite layer containing a photoconductor and another material. Photoreceptors 206 can also contain multiple layers.

Primary charging subsystem 210 uniformly electrostatically charges photoreceptor 206 of imaging member 111, shown in the form of an imaging cylinder. Charging subsystem 210 includes a grid 213 having a selected voltage. Additional components provided for control can be assembled about the various process elements of the respective printing modules 31, 32, 33, 34, 35. Meter 211 measures the uniform electrostatic charge provided by primary charging subsystem 210.

An exposure subsystem 220 is provided for selectively modulating the uniform electrostatic charge on photoreceptor 206 in an image-wise fashion by exposing photoreceptor 206 to electromagnetic radiation to form a latent electrostatic image. The uniformly-charged photoreceptor 206 is typically exposed to actinic radiation provided by selectively activating particular light sources in an LED array or a laser device outputting light directed onto photoreceptor 206. In embodiments using laser devices, a rotating polygon (not shown) is used to scan one or more laser beam(s) across the photoreceptor 206 in the fast-scan direction. One pixel site is exposed at a time, and the intensity or duty cycle of the laser beam is varied at each dot site. In embodiments using an LED array, the array can include a plurality of LEDs arranged next to each other in a line, all dot sites in one row of dot sites on the photoreceptor 206 can be selectively exposed simultaneously, and the intensity or duty cycle of each LED can be varied within a line exposure time to expose each pixel site in the row during that line exposure time.

As used herein, an “engine pixel” is the smallest addressable unit on photoreceptor 206 or receiver 42 (FIG. 1) which the exposure subsystem 220 (e.g., the laser or the LED) can expose with a selected exposure different from the exposure of another engine pixel. Engine pixels can overlap (e.g., to increase addressability in the slow-scan direction S). Each engine pixel has a corresponding engine pixel location, and the exposure applied to the engine pixel location is described by an engine pixel level.

The exposure subsystem 220 can be a write-white or write-black system. In a write-white or charged-area-development (CAD) system, the exposure dissipates charge on areas of photoreceptor 206 to which toner should not adhere. Toner particles are charged to be attracted to the charge remaining on photoreceptor 206. The exposed areas therefore correspond to white areas of a printed page. In a write-black or discharged-area development (DAD) system, the toner is charged to be attracted to a bias voltage applied to photoreceptor 206 and repelled from the charge on photoreceptor 206. Therefore, toner adheres to areas where the charge on photoreceptor 206 has been dissipated by exposure. The exposed areas therefore correspond to black areas of a printed page.

In a preferred embodiment, meter 212 is provided to measure the post-exposure surface potential within a patch area of a latent image formed from time to time in a non-image area on photoreceptor 206. Other meters and components can also be included (not shown).

A development station 225 includes toning shell 226, which can be rotating or stationary, for applying toner of a selected color to the latent image on photoreceptor 206 to produce a visible image on photoreceptor 206 (e.g., of a separation corresponding to the color of toner deposited at this printing module). Development station 225 is electrically biased by a suitable respective voltage to develop the respective latent image, which voltage can be supplied by a power supply (not shown). Developer is provided to toning shell 226 by a supply system (not shown) such as a supply roller, auger, or belt. Toner is transferred by electrostatic forces from development station 225 to photoreceptor 206. These forces can include Coulombic forces between charged toner particles and the charged electrostatic latent image, and Lorentz forces on the charged toner particles due to the electric field produced by the bias voltages.

In some embodiments, the development station 225 employs a two-component developer that includes toner particles and magnetic carrier particles. The exemplary development station 225 includes a magnetic core 227 to cause the magnetic carrier particles near toning shell 226 to form a “magnetic brush,” as known in the electrophotographic art. Magnetic core 227 can be stationary or rotating, and can rotate with a speed and direction the same as or different than the speed and direction of toning shell 226. Magnetic core 227 can be cylindrical or non-cylindrical, and can include a single magnet or a plurality of magnets or magnetic poles disposed around the circumference of magnetic core 227. Alternatively, magnetic core 227 can include an array of solenoids driven to provide a magnetic field of alternating direction. Magnetic core 227 preferably provides a magnetic field of varying magnitude and direction around the outer circumference of toning shell 226. Further details of magnetic core 227 can be found in U.S. Pat. No. 7,120,379 to Eck et al., and in U.S. Pat. No. 6,728,503 to Stelter et al., the disclosures of which are incorporated herein by reference. Development station 225 can also employ a mono-component developer comprising toner, either magnetic or non-magnetic, without separate magnetic carrier particles.

Transfer subsystem 50 of FIG. 2 includes transfer backup member 113, and intermediate transfer member 112 for transferring the respective print image 38 from photoreceptor 206 of imaging member 111 through a first transfer nip 201 to surface 216 of intermediate transfer member 112, and thence to a receiver 42a. Receivers 42d 42a are transported by transport web 81. Transfer of the print image 38 to a receiver 42a, 42d is effected by an electrical field provided to transfer backup member 113 by power source 240, which is controlled by LCU 99. Receivers 42a, 42d can be any objects or surfaces onto which toner can be transferred from imaging member 111 by application of the electric field. In this example, receiver 42d is shown prior to entry into a second transfer nip 202, and receiver 42a is shown subsequent to transfer of the print image 38.

In the illustrated embodiment of FIG. 1, receiver 42a receives a respective toned print images 38 from each printing module 31, 32, 33, 34, 35 in register to form a composite image thereon as is done with the NexPress 2100. In other embodiments, the separate toner images can be transferred in register directly from the photoreceptor 206 in the respective printing module 31, 32, 33, 34, 35 to the receiver 42a without using an intermediate transfer member 112. An alternative method of transferring toner images (not shown) involves transferring the separate toner images, in register, to a transfer member and then transferring the registered image to a receiver. Any of these transfer processes are suitable when practicing this invention.

LCU 99 sends control signals to the primary charging subsystem 210, the exposure subsystem 220, and the respective development station 225 of each printing module 31, 32, 33, 34, 35 (FIG. 1), among other components. Each printing module 31, 32, 33, 34, 35 can also have its own respective controller (not shown) coupled to LCU 99.

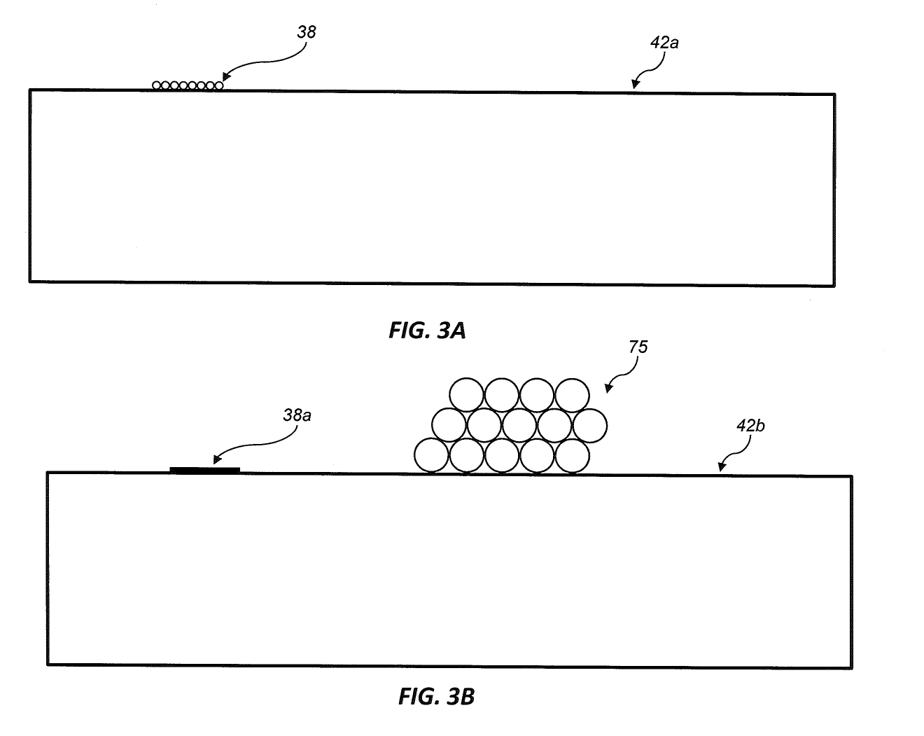

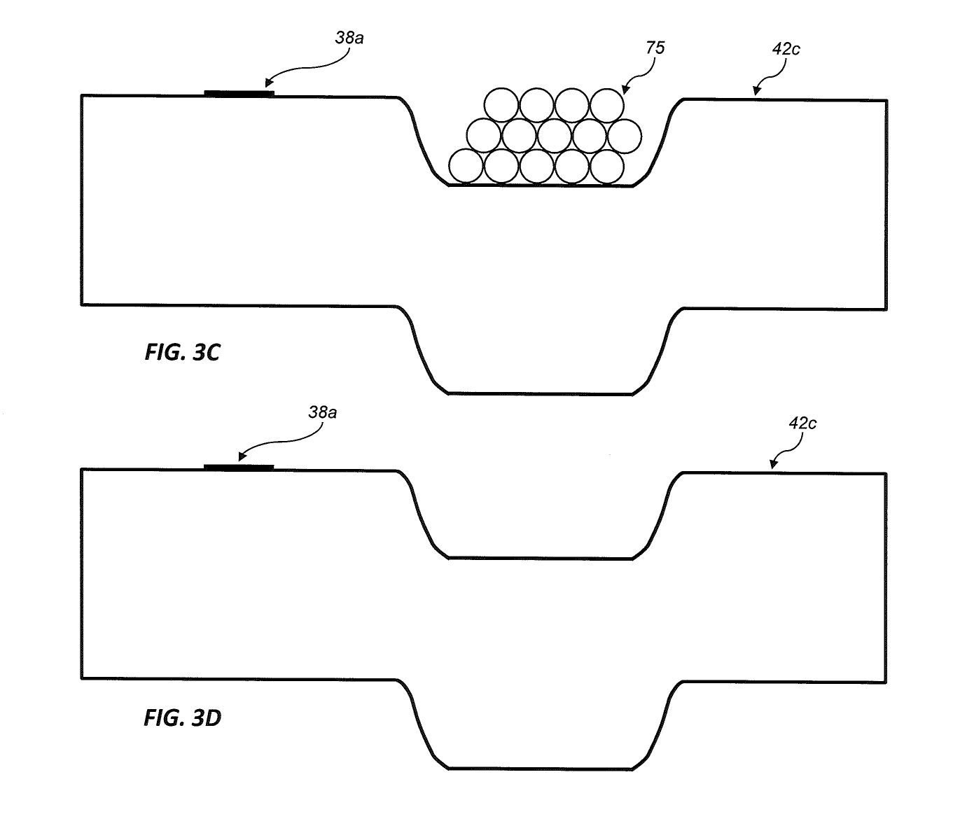

In FIG. 1, receiver 42a is shown after passing through printing module 35. FIG. 3A shows the unfused toner particles of print image 38 on receiver 42a. Subsequent to transfer of the respective print images 38 in FIG. 1., overlaid in registration, one from each of the respective printing modules 31, 32, 33, 34, 35, receiver 42a is advanced to a fuser module 60 (i.e. a fusing or fixing assembly) to fuse the print image 38 to the receiver 42a. Transport web 81 transports the print-image-carrying receivers 42 to the fuser module 60, which fixes the toner particles to the respective receivers 42, generally by the application of heat and pressure. The receivers 42 are serially de-tacked from transport web 81 to permit them to feed cleanly into the fuser module 60. The transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along the transport web 81 before or after cleaning station 86 in the direction of rotation of transport web 81.

Fuser module 60 includes a heated fusing roller 62 and an opposing pressure roller 64 that form a fusing nip 66 there between. In an embodiment, fuser module 60 also includes a release fluid application substation 68 that applies release fluid, e.g., silicone oil, to fusing roller 62. Alternatively, wax-containing toner can be used without applying release fluid to fusing roller 62. Other embodiments of fusers, both contact and non-contact, can be employed. For example, solvent fixing uses solvents to soften the toner particles so they bond with the receiver 42. Photoflash fusing uses short bursts of high-frequency electromagnetic radiation (e.g., ultraviolet light) to melt the toner. Radiant fixing uses lower-frequency electromagnetic radiation (e.g., infrared light) to more slowly melt the toner. Microwave fixing uses electromagnetic radiation in the microwave range to heat the receivers 42 (primarily), thereby causing the toner particles to melt by heat conduction, so that the toner is fixed to the receiver 42.

The fused receivers (e.g., receiver 42b carrying the fused image) are transported in series from the fuser module 60 along a path to printing module 36 that will depositing an embossing pattern of embossing particles 75 on a side of the image bearing sheet. FIG. 3B shows the receiver 42b now bearing the fused toner image 38a and also showing the embossing pattern having an embossing-pattern thickness corresponding to a fixed stack height of at least 30% of the thickness of the sheet, wherein the embossing particles 75 have average diameters greater than the average diameters of the toner particles of the image toner. Referring back to FIG. 1, printing module 36 has the same capability as printing modules 31, 32, 33, 34, 35 to form an embossing pattern on the receiver 42. Receivers 42b are then transported to the embossing station 70, where the hard embossing roller 71 and the compliant embossing roller 72 forms a nip pressing the image bearing sheet of paper between a hard nip roller and a compliant nip roller, the pressure being selected so that the embossing pattern permanently deforms the sheet as shown in FIG. 3C. The embossed sheet 42c now passes to the embossing particle removal station 73 (FIG. 1) that has means 74 (FIG. 1) to remove the embossing particles 75 from the embossed sheet 42c. FIG. 3C shows an enlarged view of the embossed sheet 42c after passing through embossing station 70 (FIG. 1) FIG. 3D shows an enlarged view of the embossing sheet 42c after it passes the embossing particle removal station 73 of FIG. 1. The embossing particles 75 used in print module 36 preferably have a diameter in the range of 15 to 40 urn. In some cases, the embossing particles are toner particles. The embossing particles 75 can be shaped like spheres, or can be irregular, for example having beveled edges.

The means 74 for removing the embossing particles 75 from the embossed sheet 42c after embossing the receiver can include applying vacuum, pressurized air, or electrostatic forces to move at least some embossing particles away from the image bearing sheet. The removal step can also include, after the removing step, transporting the removed embossing particles 75 to the supply container for reuse.

Embossing requires that the embossing particles 75 be hard enough so that the embossed sheet 42c is preferentially deformed when passing though the embossing rollers. It is also important to not damage the toner image, for example by cracking the toner when the embossing pressure is applied. Both of these objectives can be achieved by reheating the image toner pattern to a temperature between its Tg-15° C. and its Tg-5° C. during the embossing step. If reheating is applied, then the embossing particles should have a softening temperature higher than the glass transition temperature of the image toner. Preferably, the embossing particles 75 have a softening temperature at least 10° C. higher than the glass transition temperature of the image toner. The method of reheating the toner image can include exposing the pressed sheet to electromagnetic radiation in a selected wavelength range, so that the toner particles are softened.

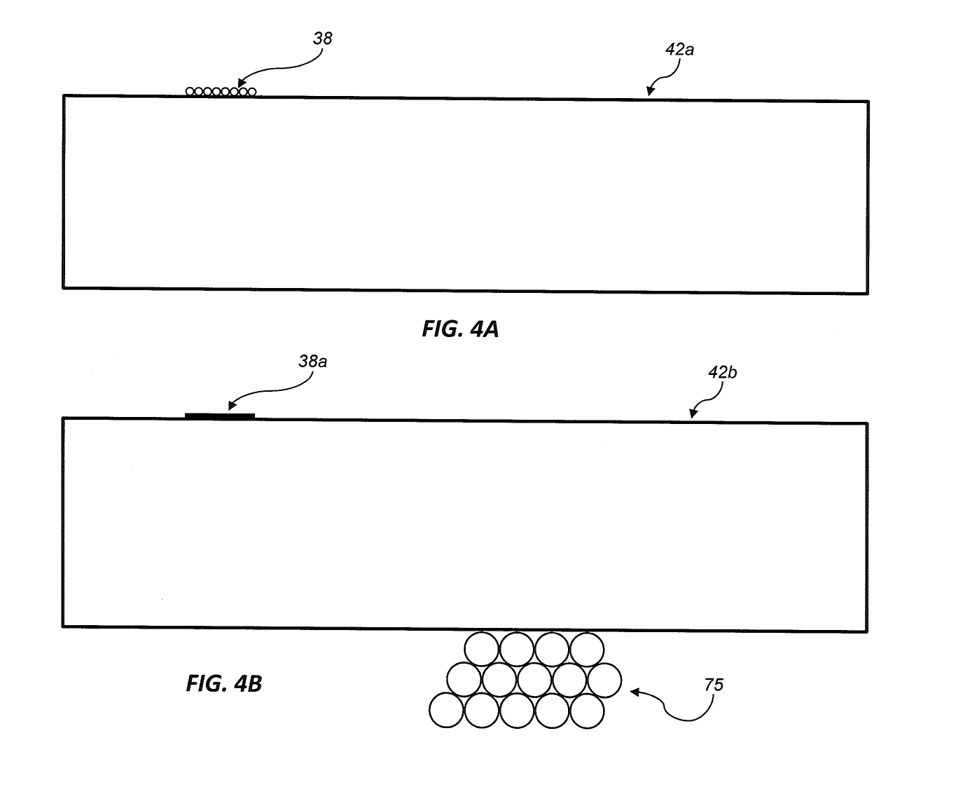

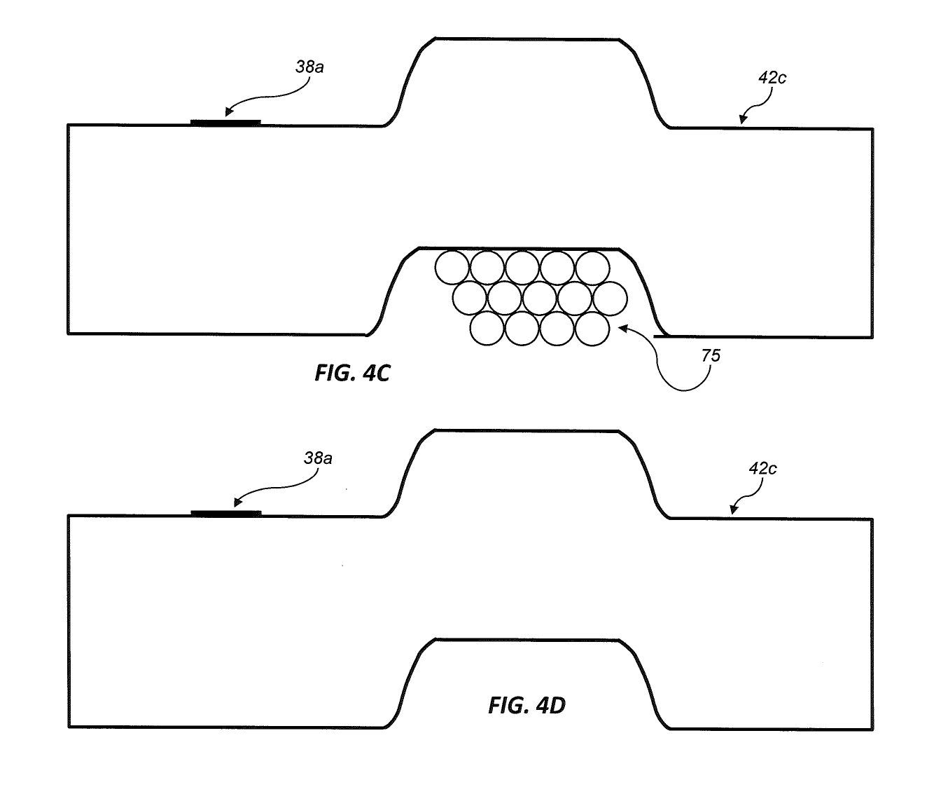

Printer 100 shows one particular embodiment of this invention, and the stations and order of toner and embossing particle lay down can be rearranged according to other embodiments of this invention. In particular additional paper path means 74 can cause the paper to be flipped over before the embossing step or the paper can be printed in duplex (both sides) prior to the embossing step. In this manner, in some cases, the embossing particles 75 are deposited on the first side of the image bearing sheet. In other modes, the embossing particles 75 are deposited on the second side of the image bearing sheet. FIGS. 4A though 4D shows the method where the toner is applied (FIG. 4A) to the first side of the receiver 42a, and the embossing particles are applied to the second side of the receiver 42 b (FIG. 4B). Then the embossed sheet 42c passes through the embossing rollers and the embossed sheet 42c becomes deformed in the area of the embossing particles 75 (FIG. 4C), and finally, the embossing particles 75 are removed (FIG. 4D). In another case (not shown), the print image 38 can be placed on either or both sides of the sheet.

The embossing particles 75 can also be placed on both sides of the sheet. The embossing patterns are designed to enhance the relief of the pattern. This is achieved, for example, by using an embossing pattern on the second side of the sheet that forms an outline of the embossing pattern on the first side of the sheet.

In another example of rearranging the sequential order of the method described above, it is possible to deposit the image toner on the sheet, the image toner including toner particles, and then deposit the embossing pattern of embossing particles 75 on the sheet, press the sheet of paper between a hard nip roller and a compliant nip roller, the pressure selected with a large enough load so that the embossing pattern permanently deforms the sheet; and then passing the sheet with the pattern of image toner onto the sheet through the fusing station to fix the toner pattern of image toner onto the sheet.

It also possible to use the fixing rollers to both fix the toner and emboss the sheet by passing the sheet through a fixing nip having rollers rotating at a selected fixing speed, the roller facing the first side being compliant, and then passing the sheet through the fixing nip a second time having the rollers rotating at a selected embossing speed greater than the selected fixing speed, such that at the higher speed the compliant rollers can't spring back, so the receiver 42 is embossed. This second embossing pass is further enhanced by including passing the sheet and a heat-blocking sheet through the fixing nip simultaneously, wherein the rollers are rotating at a selected embossing speed while pressing. The heat-blocking sheet keeps the toner layer from softening and reduces the effective compliance of the compliant roller, thus improving embossing. The heat-blocking sheet can be made of polyimide, silverized polyester, or stainless steel.

In some cases, the receiver 42 will still be resistant to embossing. In such a case the method can further include depositing a pattern of moistening liquid on the sheet before embossing. The pattern of moistening liquid can simply correspond to the embossing pattern; it does not have to exactly match the embossing pattern.

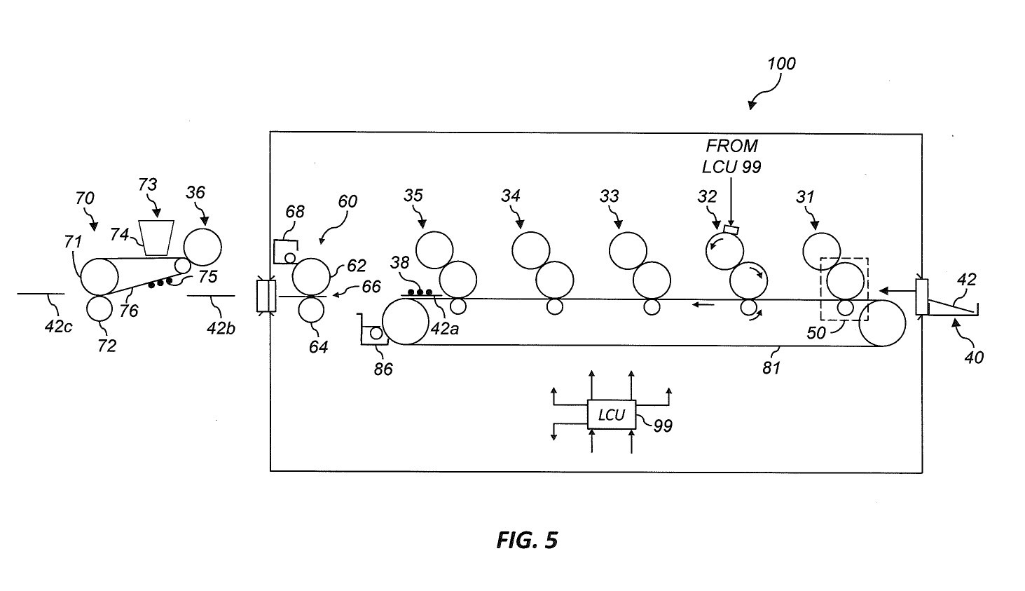

FIG. 5 shows another embodiment of this invention Subsequent to transfer of the respective print images 38, overlaid in registration, one from each of the respective printing modules 31, 32, 33, 34, 35, receiver 42a is advanced to a fuser module 60 (i.e. a fusing or fixing assembly) to fuse the print image 38 to the receiver 42a. Receiver 42b is shown after passing through printing module 35. Print image 38 on receiver 42b includes fused toner particles.

The fused receivers (e.g., receiver 42b carrying fused image) are transported in series from the fuser module 60 along a path to the embossing station 70. In the embossing station 70, printing module 36 will apply the embossing particles 75 to an embossing endless web (shown) or embossing sheet (not shown), having an embossing-pattern thickness corresponding to a fixed stack height of at least 30% of the thickness of the sheet, wherein the embossing particles having average diameters greater than the average diameters of the toner particles of the image toner. The printing module 36 has the same capability as printing modules 31, 32, 33, 34, 35 to form an embossing pattern on the receiver 42b. Receiver 42b is transported to the embossing station 70, where the hard embossing roller 71 and the compliant embossing roller 72 forms a nip to pass the embossing web 76 and receiver 42b with sufficient pressure to deform the embossed sheet 42c in the pattern formed by the embossing particles 75. The embossed sheet 42c now passes to the exit of the printer. The embossing endless web passes on to a particle removal station 73 that has means 74 to remove the embossing particles 75 from the embossed sheet 42c. Alternatively, the embossed particles can be tacked to the embossing web 76 (shown) or embossing sheet (not shown) so that the embossing pattern can reused for multiple image bearing sheets. In this method the embossing particles 75 are not removed from the embossing web 76 or embossing sheet. When a new embossing pattern is needed, then the embossing web 76 or embossed sheet would be discarded or reconditioned so that a new embossing pattern can be created.

Not shown in FIG. 5 are optional paper path means 74 that can cause the paper to be flipped over before the embossing step or the paper can be printed in duplex (both sides) prior to the embossing step. In this manner, in some cases, the embossing particles 75 are pressed into the first side of the image bearing sheet. In other modes, the embossing particles 75 are pressed into the second side of the image bearing sheet

The embossing pressure can be applied by a pair of hard nipping rollers or optionally, with rollers where the roller facing the first side is compliant and the roller facing the second side is hard. One or both of the rollers can be heated to provide the softening effect for the image toner particles, and optionally a heat-blocking sheet can be passed through the fixing nip simultaneously, wherein the rollers are rotating at a selected embossing speed while pressing.

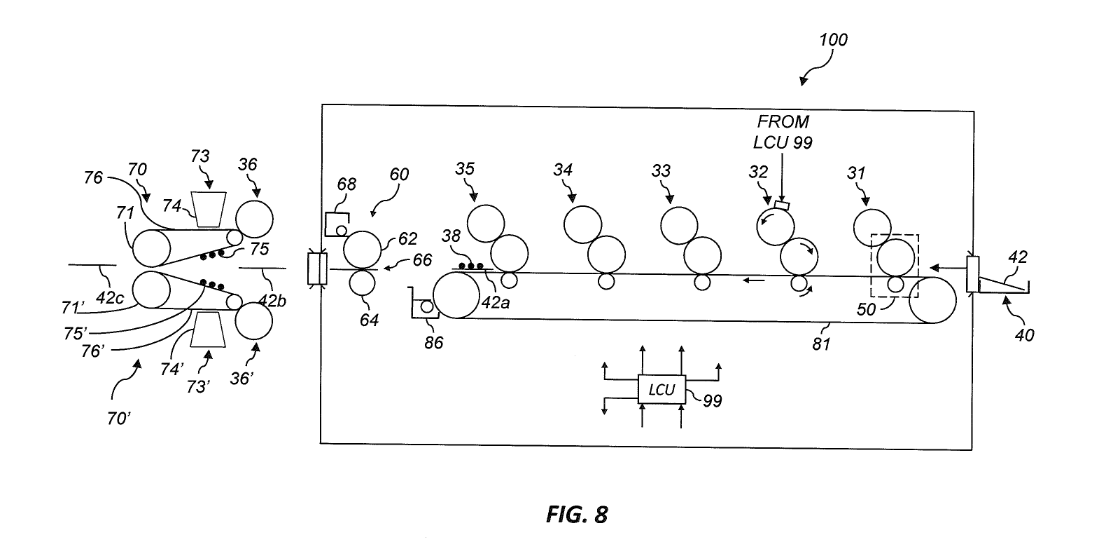

Another embodiment, shown in FIG. 8, uses two embossing sheets (not shown) or embossing webs 76, 76′ with complementary images to enhance the relief of the embossing pattern. The embossing sheets or embossing webs 76, 76′ would be aligned on either side of the fused image receiver 42b and the receiver 42b would travel together with the two embossing webs 76, 76′ (or two embossing sheets not shown) through two hard rollers 71, 71′ or one hard and one compliant roller to deform the image bearing sheet, the pressure being selected so that the embossing pattern permanently deforms the sheet. The two embossing patterns are designed to enhance the relief of the pattern, for example, by using an embossing pattern on the second sheet that is an outline of the embossing pattern on the first sheet.

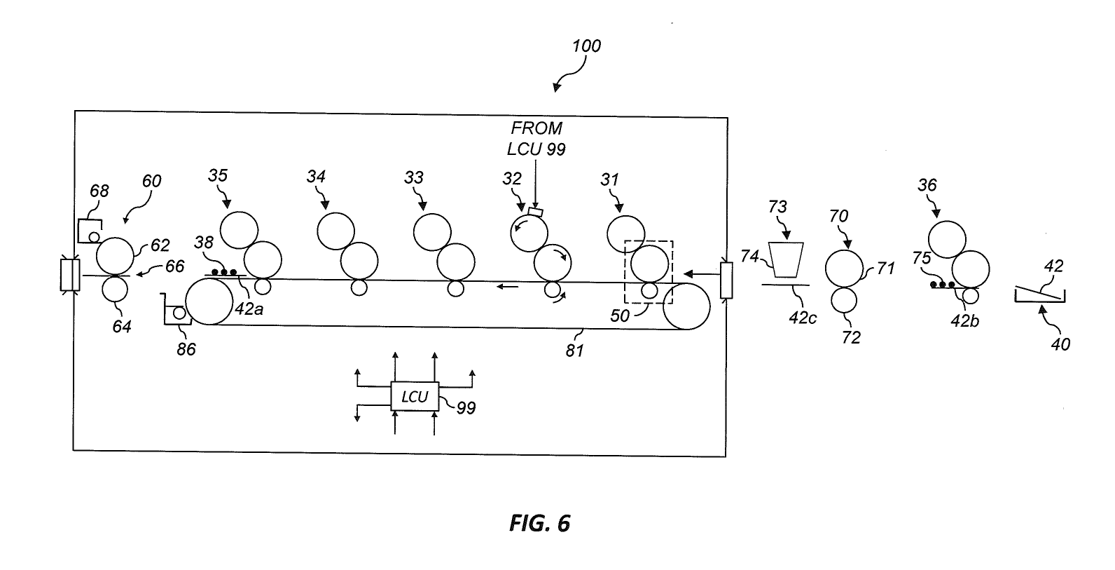

FIG. 6 shows an embodiment where the embossing of the image sheet is done before printing the image to the sheet. Referring to FIG. 6, receiver 42 is transported from supply unit 40, which can include active feeding subsystems as known in the art, into printing module 36. Receiver 42 is, for example, a selected section of a web of, or a cut sheet of, planar media such as paper or transparency film. The receivers 42, 42b are transported in series from the supply unit 40 along a path to printing module 36 that will deposit an embossing pattern of embossing particles 75 on a side of the image bearing sheet. The printing module 36 has the same capability as printing modules 31, 32, 33, 34, 35 to form an embossing pattern on the receiver 42. Receivers 42b are then transported to the embossing station 70, where the hard embossing roller 71 and the compliant embossing roller 72 forms a nip pressing the image bearing sheet of paper between a hard nip roller and a compliant nip roller, the pressure being selected so that the embossing pattern permanently deforms the sheet. The embossed sheet 42c now passes to the printer 100. Printer 100 is adapted to produce images, such as single-color images (i.e., monochrome images), or multicolor images such as CMYK, or pentachrome (five-color) images, on the embossed sheet 42c.

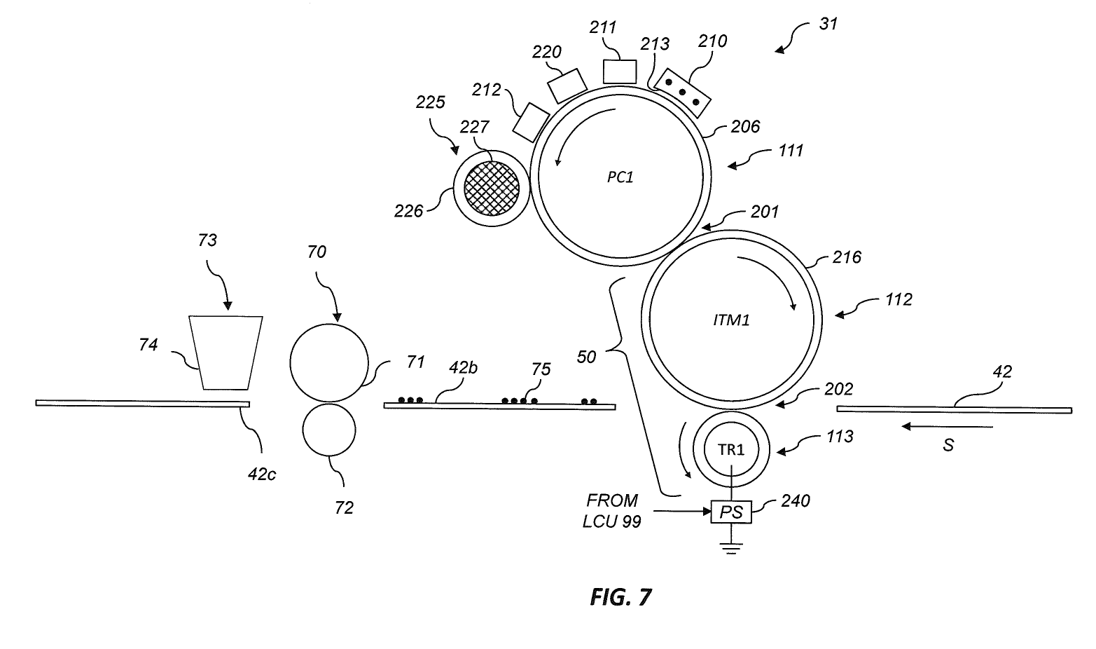

FIG. 7 shows a digital embossing machine. Shown are the print module 31, embossing station 70, and means 74 for removing the embossing particles 75. This apparatus can be used in to produce embossed sheets 42c with digitally produced embossing patterns. The printing module 31 was previously described in FIG. 2. By using embossing particles in the developer applied by the development station 225, an embossing pattern is transferred onto the receiver 42, the embossing pattern having an embossing-pattern thickness corresponding to a fixed stack height of at least 30% of the thickness of the sheet, wherein the embossing particles 75 have average diameters in the range of 15 to 40 urn. Passing the receiver 42b to the embossing station 70, where the hard embossing roller 71 and the compliant embossing roller 72 forms a nip to pass with sufficient pressure to emboss the receiver 42b by deforming the sheet in the pattern formed by the embossing particles 75. The embossed sheet 42c now passes on to a particle removal station 73 that has means 74 to remove the embossing particles 75 from the embossed sheet 42c.

The invention has been described in detail with particular reference to certain preferred embodiments thereof, but it will be understood that variations and modifications can be effected within the spirit and scope of the invention.

### PARTS LIST

S slow scan direction
31-35 printing modules
36 print module
38 print image
38a the fused toner image
40 supply unit
42 receiver
42a receiver
42b receiver (with fused image)
42c embossed sheet
42d receiver
50 transfer subsystem
60 fuser module
62 heated fusing roller
64 opposing pressure roller
66 fusing nip
68 release fluid application substation
70 embossing station
71 hard embossing roller
72 compliant embossing roller
73 embossing particle removal station
74 means to remove the embossing particles
75 embossing particles
76 embossing web
76′ embossing web
81 transport web
86 cleaning station
99 logic and control unit (LCU)
100 printer
111 imaging member
112 intermediate transfer member
113 transfer backup member
201 first transfer nip
202 second transfer nip
206 photoreceptor
210 Primary charging subsystem
211 meter
212 meter
213 grid
216 intermediate transfer member surface
220 exposure subsystem
225 development station
226 toning shell
227 magnetic core
240 power source

1. A device for embossing a receiver having a thickness, comprising:
a) means for depositing an embossing pattern of embossing particles
b) means to press the receiver of receiver between a hard nip roller and a compliant nip roller, the pressure selected so that with a large enough load so that the embossing pattern permanently deforms the receiver;
c) wherein, the embossing pattern includes a digitally created pattern of embossing toner particles having an embossing-pattern thickness corresponding to a fixed stack height of at least 30% of the thickness of the receiver.

2. The device of claim 1, wherein the embossing particles electrically charged toner particles transferred to the receiver with an applied electric field.

3. The device of claim 1, wherein the receiver and a non-compliant sheet or belt pass through a fixing nip simultaneously.

4. The device of claim 1, wherein the embossing particles are fixed to the receiver.

5. The device of claim 1, further including means to remove unfixed embossing particles from the receiver.
